(19) United States
(12) Patent Application Publication
(10) Pub. No.: US 2026/0132888 A1
(43) Pub. Date: May 14, 2026

(54) HANDHELD GIMBAL

(71) Applicant: ARASHI VISION INC., Shenzhen (CN)

(72) Inventors: Lifen LU, Shenzhen (CN); Gu CHEN, Shenzhen (CN)

(73) Assignee: ARASHI VISION INC., Shenzhen (CN)

(21) Appl. No.: 19/445,685

(22) Filed: Jan. 12, 2026

Related U.S. Application Data
(63) Continuation of application No. PCT/CN2023/122587, filed on Sep. 28, 2023.

(51) Int. Cl. F16M 13/04; F16M 11/04; F16M 11/10; F16M 11/18; F16M 11/20

(52) U.S. Cl. CPC F16M 13/04; F16M 11/041; F16M 11/105; F16M 11/18; F16M 11/2064

(57) ABSTRACT

A handheld gimbal includes a handle and a first shaft assembly including a first motor and a first shaft arm disposed on the handle, the first shaft arm including a first sub-arm and a second sub-arm, one end of the first sub-arm being connected to the first motor. In a radial direction of the first motor, the first sub-arm at least partially protrudes from an outer peripheral surface of the first motor. The first sub-arm has a first surface and a second surface opposite to each other, the first surface being located at a side of the first motor away from the handle. The first motor is configured to drive the first sub-arm to rotate relative to the handle, and the handheld gimbal is configured to switch between an unfolded state and a folded state. In the folded state, the second sub-arm is stored within the second surface.

### CROSS-REFERENCE TO RELATED APPLICATION

The present application is a continuation of International Application No. PCT/CN2023/122587, filed Sep. 28, 2023, the entire content of which is incorporated herein by reference in its entirety.

### TECHNICAL OF FIELD

This application relates to a field of gimbal technology, and in particular to a handheld gimbal.

### BACKGROUND

A handheld gimbal can be used to stabilize a shooting device and adjust a posture of the shooting device to meet different shooting needs of a user.

Some traditional handheld gimbals have both unfolded and folded states. However, the folded state of traditional handheld gimbals is not compact enough, takes up a lot of space, is not easy to store, and affects user experience.

### SUMMARY

In a first aspect, a handheld gimbal includes a handle and a first shaft assembly including a first motor and a first shaft arm disposed on the handle, the first shaft arm including a first sub-arm and a second sub-arm rotatably connected to the first sub-arm, one end of the first sub-arm being connected to the first motor. In a radial direction of the first motor, the first sub-arm at least partially protrudes from an outer peripheral surface of the first motor. The first sub-arm has a first surface and a second surface opposite to each other, the first surface being located a side of the first motor away from the handle. The first motor is configured to drive the first sub-arm atto rotate relative to the handle, and the handheld gimbal is configured to switch between an unfolded state and a folded state. In the folded state, the second sub-arm is stored within the second surface.

In a second aspect, a handheld gimbal includes a handle and a first shaft assembly, the first shaft assembly includes a first motor and a first shaft arm disposed on the handle. The first shaft arm includes a first sub-arm and a second sub-arm rotatably connected to the first sub-arm, one end of the first sub-arm is connected to the first motor, and the first motor is configured to drive the first sub-arm to rotate relative to the handle. The handheld gimbal is configured to switch between an unfolded state and a folded state. During the process of switching from the unfolded state to the folded state, the second sub-arm first rotates away from the handle, and then rotates towards an outer periphery of the handle until the second sub-arm is at least partially parallel to the first sub-arm.

### BRIEF DESCRIPTION OF THE DRAWINGS

To more clearly illustrate the technical solutions in the embodiments of this application or the conventional technology, the drawings used in the description of the embodiments or the conventional technology will be briefly introduced below. Obviously, the drawings described below are only some embodiments of this application. For those skilled in the art, other drawings can be obtained based on these drawings without creative effort.

FIG. 1 is a structural schematic diagram of a handheld gimbal provided in one embodiment of this application.

FIG. 2 is another structural schematic diagram of a handheld gimbal provided in one embodiment of this application.

FIG. 3 is another structural schematic diagram of a handheld gimbal provided in one embodiment of this application.

FIG. 4 is another structural schematic diagram of a handheld gimbal provided in one embodiment of this application.

FIG. 5 is another structural schematic diagram of a handheld gimbal provided in one embodiment of this application.

FIG. 6 is another structural schematic diagram of a handheld gimbal provided in one embodiment of this application.

FIG. 7 is another structural schematic diagram of a handheld gimbal provided in one embodiment of this application.

FIG. 8 is a structural schematic diagram of a handheld gimbal provided in one embodiment of this application.

FIG. 9 is another structural schematic diagram of a handheld gimbal provided in one embodiment of this application.

FIG. 10 is another structural schematic diagram of a handheld gimbal provided in one embodiment of this application.

FIG. 11 is another structural schematic diagram of a handheld gimbal provided in one embodiment of this application.

FIG. 12 is another structural schematic diagram of a handheld gimbal provided in one embodiment of this application.

FIG. 13 is a partial schematic diagram of a handheld gimbal provided in one embodiment of this application.

FIG. 14 is another structural schematic diagram of a handheld gimbal provided in one embodiment of this application.

FIG. 15 is another structural schematic diagram of a handheld gimbal provided in one embodiment of this application.

FIG. 16 is another structural schematic diagram of a handheld gimbal provided in one embodiment of this application.

FIG. 17 is another structural schematic diagram of a handheld gimbal provided in one embodiment of this application.

FIG. 18 is another structural schematic diagram of a handheld gimbal provided in one embodiment of this application.

FIG. 19 is another structural schematic diagram of a handheld gimbal provided in one embodiment of this application.

FIG. 20 is another structural schematic diagram of a handheld gimbal provided in one embodiment of this application.

FIG. 21 is another structural schematic diagram of a handheld gimbal provided in one embodiment of this application.

### FIGURE SYMBOLS

10. Handheld gimbal; 20. Shooting device; 100. First shaft assembly; 110. First motor; 120. First shaft arm; 121. First sub-arm; 1211. First surface; 1212. Second surface; 122. Second sub-arm; 200. Second shaft assembly; 210. Second motor; 220. Second shaft arm; 230. Clearance space; 231. Clearance groove; 232. Clearance opening; 300. Third shaft assembly; 310. Third motor; 320. Clamping member; 400. Handle; 500. Button; 600. Control component; 700. Rotating member; 710. Rotating shaft; 800. Fixing structure; 810. Snap-fit protrusion; 820. Snap-fit recess; a. First predetermined angle; b. Second predetermined angle.

### DETAILED DESCRIPTION

The technical solutions of some embodiments of this application will be clearly and completely described below with reference to accompanying drawings. Obviously, the described embodiments are only some embodiments of this application, and not all embodiments. Based on the embodiments of this application, all other embodiments obtained by those skilled in the art without creative effort are within the scope of protection of this application.

To make the above-mentioned objectives, features, and advantages of this application more apparent and understandable, the specific embodiments of this application are described in detail below with reference to the accompanying drawings. Many specific details are set forth in the following description to provide a thorough understanding of this application. However, this application can be implemented in many other ways different from those described herein, and those skilled in the art can make similar modifications without departing from the spirit of this application. Therefore, this application is not limited to the specific embodiments disclosed below.

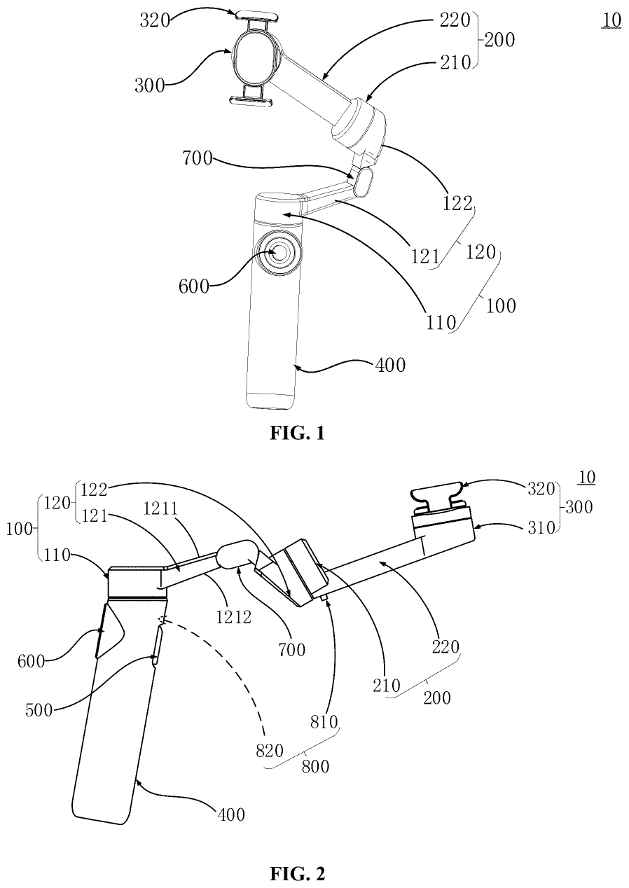

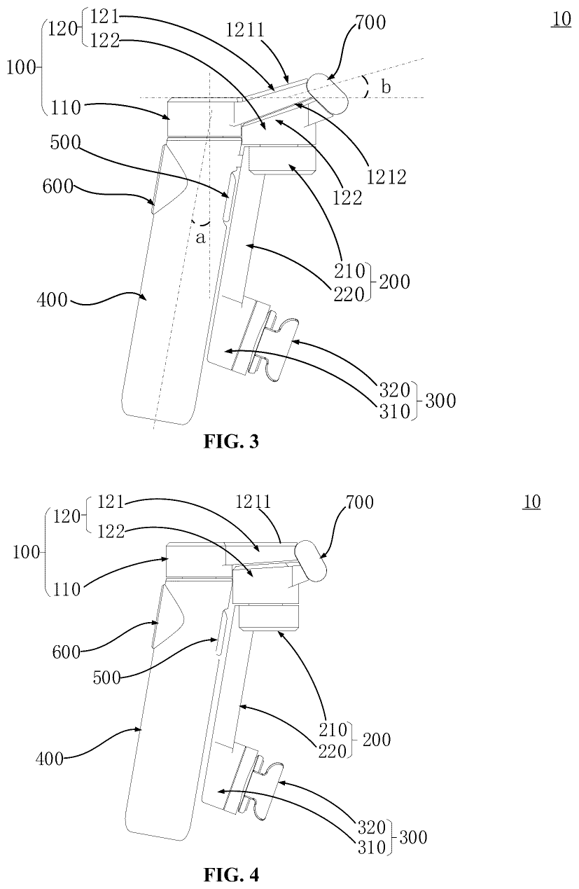

Please refer to FIGS. 1 to 5. In some embodiments, this application provides a handheld gimbal 10, which is configured to switch between an unfolded state and a folded state. As shown in FIG. 1, the handheld gimbal 10 is in the unfolded state. As shown in FIG. 3, the handheld gimbal 10 is in the folded state. The handheld gimbal 10 includes a handle 400 and at least two shaft assemblies, which can be configured to support and drive a shooting device 20 to adjust a posture of the shooting device 20.

As shown in FIGS. 1, 2, and 3, in some embodiments, the at least two shaft assemblies include a first shaft assembly 100. The first shaft assembly 100 includes a first motor 110 and a first shaft arm 120 disposed on the handle 400. The first shaft arm 120 includes a first sub-arm 121 and a second sub-arm 122. One end of the first sub-arm 121 is rotatably connected to one end of the second sub-arm 122, and the other end of the first sub-arm 121 is connected to the first motor 110. In a radial direction of the first motor 110, the first sub-arm 121 at least partially protrudes from an outer peripheral surface of the first motor 110. The first sub-arm 121 has a first surface 1211 and a second surface 1212 disposed opposite to each other. The first surface 1211 is located at a side of the first motor 110 away from the handle 400. The first motor 110 is configured to drive the first sub-arm 121 to rotate relative to the handle 400. In a folded state, the second sub-arm 122 is stored within the second surface 1212.

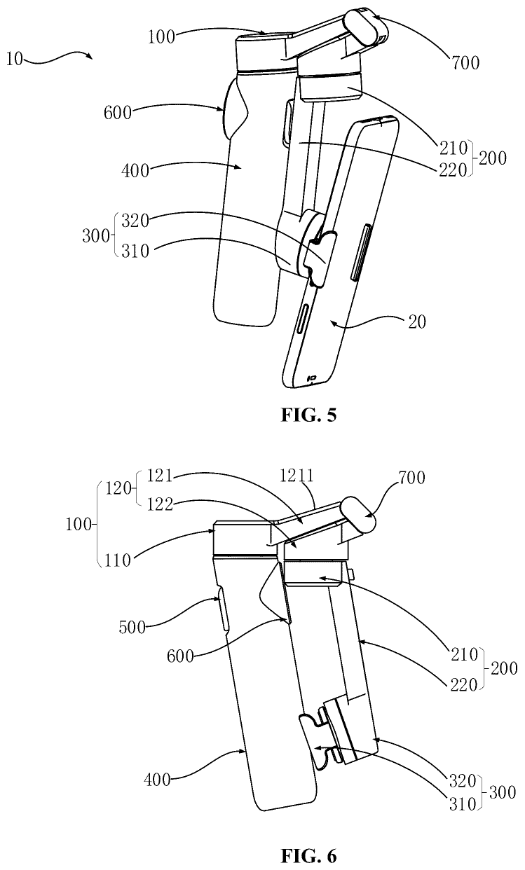

The aforementioned handheld gimbal 10 has at least the following beneficial effects: the first sub-arm 121 protrudes at least partially from the outer peripheral surface of the first motor 110 along the radial direction of the first motor 110. This can be roughly considered as a portion of the first sub-arm 121 protruding outward and suspended above the outer peripheral surface of the handle 400. The first sub-arm 121 has a first surface 1211 and a second surface 1212 arranged opposite to each other. The first surface 1211 of the first sub-arm 121 is located on the side of the first motor 110 away from the handle 400, and the second surface 1212 is arranged opposite to the first surface 1211. As shown in FIGS. 3 and 4, when the handheld gimbal 10 is folded, its second sub-arm 122 is stored within the second surface 1212 of the first sub-arm 121. This can be roughly considered as the second sub-arm 122 being stored below the first sub-arm 121 along an axial direction of the handle 400 and at the outer periphery of the handle 400. This makes efficient use of the space around the outer periphery of the handle 400, resulting in a more compact and aesthetically pleasing structure. Furthermore, the overall size and space occupied by the handheld gimbal 10 along the axial direction of the handle 400 are reduced, facilitating storage and improving user experience. Understandably, traditional handheld gimbals 10s typically involve stacking at least a part of the arm components at the end of the handle 400 when folded, which results in the folded handheld gimbal 10 being excessively long along the axial direction of the handle 400, making storage inconvenient and unsightly.

Please refer to FIGS. 1, 2 and 3. In some embodiments, the at least two shaft assemblies further include a second shaft assembly 200. The second shaft assembly 200 includes a second motor 210 connected to the second sub-arm 122 and a second shaft arm 220. One end of the second shaft arm 220 is connected to the second motor 210. The second motor 210 is configured to drive the second shaft arm 220 to rotate. In the folded state, at least one of the second shaft arm 220 or the second sub-arm 122 is in contact with the handle 400.

For example, in one embodiment, in the folded state of the handheld gimbal 10, the second shaft arm 220 is in contact with the outer peripheral surface of the handle 400. In another embodiment, in the folded state of the handheld gimbal 10, the second sub-arm 122 is in contact with the outer peripheral surface of the handle 400. In yet another embodiment, in the folded state of the handheld gimbal 10, both the second shaft arm 220 and the second sub-arm 122 are in contact with the outer peripheral surface of the handle 400.

In other words, when the handheld gimbal 10 is folded, its second shaft arm 220 and/or second sub-arm 122 can fit against the outer periphery of the handle 400, making full use of the space on the outer periphery of the handle 400, reducing the gap, and further increasing the overall structural compactness of the handheld gimbal 10. This improves structural stability of the handheld gimbal 10 in the folded state, and makes it smaller in size, which is more conducive to storage and carrying.

It should be noted that, as shown in FIGS. 2 and 3, a stator or rotor of the second motor 210 of the second shaft assembly 200 is fixed to the second sub-arm 122 of the first shaft arm 120 of the first shaft assembly 100. It can be considered that the second sub-arm 122 provides a part of the structure for the housing of the second motor 210. In other words, a part of the motor housing of the second motor 210 can also be considered as at least a part of the structure of the second sub-arm 122.

Please refer to FIGS. 1, 2, and 3. In some embodiments, the at least two shaft assemblies further include a third shaft assembly 300. The third shaft assembly 300 includes a clamping member 320 for holding a shooting device 20 and a third motor 310. The third motor 310 and the second motor 210 are respectively connected to two ends of the second shaft arm 220 that are far apart from each other. The third motor 310 is connected to the clamping member 320 and is configured to drive the clamping member 320 and the shooting device 20 to rotate. It should be noted that the first motor 110 can be a yaw motor, and the motor shaft of the first motor 110 can be a yaw motor shaft. The second motor can be a pitch motor, and correspondingly, the motor shaft of the second motor 210 can be a pitch motor shaft. The third motor 310 can be a roll motor. This is a further explanation of the first motor 110, the second motor 210 and the third motor 310 mentioned herein, which is intended to help understand the operating principle of the handheld gimbal 10 of this application, and is not intended to indicate or imply that the first motor 110, the second motor 210 and the third motor 310 can only be as described above. Therefore, the above can be interpreted more broadly as long as it can satisfy the beneficial effects to be achieved by the handheld gimbal 10 of this application.

For example, in the embodiments shown in FIGS. 4 and 5, in the folded state, the third motor 310 is located between the clamping member 320 and the handle 400. In the folded state, the handheld gimbal 10 has its third motor 310 located between the clamping member 320 and the handle 400. This can be considered as the clamping member 320 facing away from the outer circumference of the handle 400, and the opening of the clamping member 320 facing outwards radially along the handle 400. This structural arrangement not only makes the handheld gimbal 10 more compact but also allows the clamping member 320 to continue clamping the shooting device 20 even in the folded state. At this time, the user can choose to store the handheld gimbal 10 and the shooting device 20 together or choose to use the folded handheld gimbal 10 to carry the shooting device 20 and continue using it.

For example, in the embodiment shown in FIG. 6, in the folded state, the clamping member 320 is located between the third motor 310 and the handle 400. This can be considered as the clamping member 320 facing the outer circumferential surface of the handle 400, and the opening of the clamping member 320 facing radially inward along the handle 400. This folded state helps protect the clamping member 320 and reduces the risk of damage during storage.

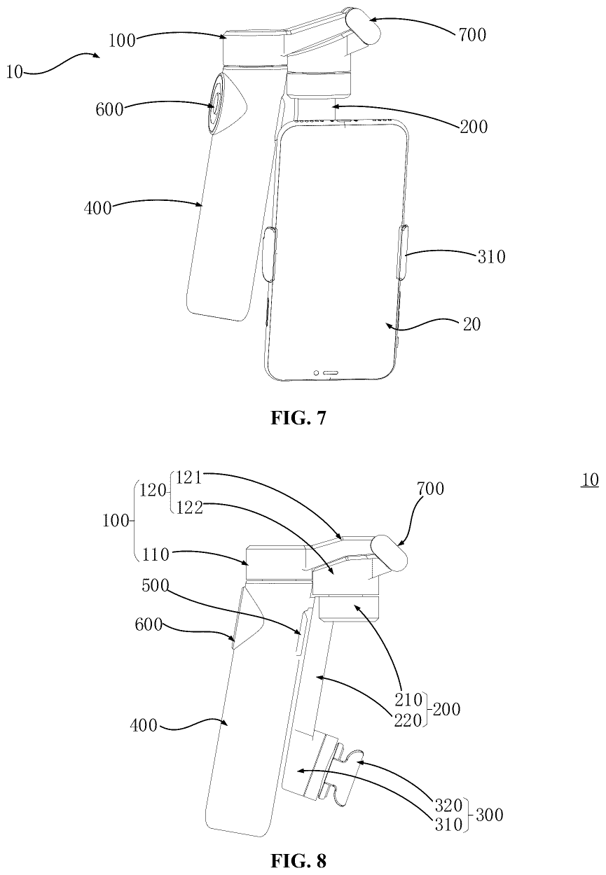

For example, in the embodiment shown in FIG. 7, when the clamping member 320 is in the folded state, an orientation of the clamping member 320 is between that in FIGS. 5 and 6. It can be considered that the clamping member 320 is set to the side, that is, the opening of the clamping member 320 is neither facing the outer peripheral surface of the handle 400 nor facing away from the outer peripheral surface of the handle 400. In this state, the clamping member 320 can also continue to clamp the shooting device 20. At this time, the user can choose to store the handheld gimbal 10 together with the shooting device 20 or choose to use the handheld gimbal 10 in the folded state to support the shooting device 20 and continue to use the shooting device 20.

Referring to FIGS. 1, 2, and 3, in some embodiments, during a transition of the handheld gimbal 10 from the unfolded state to the folded state, the second sub-arm 122 first rotates away from the handle 400, and then rotates towards the outer periphery of the handle 400 until the second sub-arm 122 is at least partially parallel to the first sub-arm 121. Conversely, during the transition of the handheld gimbal 10 from the folded state to the unfolded state, it can be considered that the second sub-arm 122 first rotates away from the outer periphery of the handle 400. In some embodiments, as shown in FIG. 1, the first motor 110 is located at the top of the handle 400. In an unfolded state of the handheld gimbal 10, the second shaft assembly 200 and the third shaft assembly 300 are approximately located on the side of the first motor 110 facing away from the handle 400, which can be considered as the second shaft assembly 200 and the third shaft assembly 300 being located axially above the first motor 110.

For example, as shown in FIGS. 1, 2 and 3, during the process of the handheld gimbal 10 switching from the unfolded state to the folded state, it can be considered that the second sub-arm 122 first rotates in a direction away from the top of the handle 400, and then the second sub-arm 122 rotates in a direction closer to the outer peripheral surface of the handle 400, until the second sub-arm 122 is at least partially parallel to the first sub-arm 121.

For example, as shown in FIGS. 1, 2 and 3, during the process of the handheld gimbal 10 switching from the unfolded state to the folded state, it can be considered that the second sub-arm 122 first rotates away from the first motor 110, and then the second sub-arm 122 rotates towards the outer peripheral surface of the handle 400 until the second sub-arm 122 is at least partially parallel to the first sub-arm 121.

The aforementioned handheld gimbal 10 can be used to support and drive the shooting device 20, and it has at least the following beneficial effects: during the process of switching the handheld gimbal 10 from the unfolded state to the folded state, its second sub-arm 122 can first rotate away from the handle 400, and then the second sub-arm 122 rotates towards the outer periphery of the handle 400 until the second sub-arm 122 is at least partially parallel to the first sub-arm 121, as shown in FIGS. 3 and 4. This can be roughly considered as the second sub-arm 122 being stored in the outer periphery of the handle 400, making reasonable use of the space in the outer periphery of the handle 400, resulting in a more compact and aesthetically pleasing structure. Furthermore, the overall size and space occupied by the handheld gimbal 10 in the axial direction of the handle 400 are reduced, making it easier to store and improving the user experience. It is understandable that traditional handheld gimbals 10 are typically folded and stored by stacking the various arm components at the end of the handle 400, which results in the folded handheld gimbal 10 being too long in the axial direction of the handle 400, making storage inconvenient and unsightly.

In some embodiments, a stator of the first motor 110 is connected to one of the handle 400 or the first sub-arm 121, and a rotor of the first motor 110 is connected to the other of the handle 400 or the first sub-arm 121.

In some embodiments, the stator of a second motor 210 is connected to one of the second shaft arm 220 or the second sub-arm 122, and a rotor of the second motor 210 is connected to the other of the second shaft arm 220 or the second sub-arm 122.

Referring to FIG. 3, in some embodiments, in the folded state, a portion of the surface of the first sub-arm 121 is parallel to a portion of the surface of the second sub-arm 122. For example, referring to FIGS. 2 and 3, in some embodiments, the second sub-arm 122 is parallel to the second surface 1212 of the first sub-arm 121. This structural arrangement makes the first sub-arm 121 and the second sub-arm 122 more neat and aesthetically pleasing in the folded state, making the handheld gimbal 10 look more neat and aesthetically pleasing overall.

Specifically, as shown in FIGS. 3 and 4, in some embodiments, in the folded state, the first sub-arm 121 is attached to the second sub-arm 122.

More specifically, in some embodiments, the second sub-arm 122 is attached to the second surface 1212 of the first sub-arm 121. This structural arrangement allows the first sub-arm 121 and the second sub-arm 122 to be compact in the folded state, making the handheld gimbal 10 appear more compact overall, improving structural stability of the handheld gimbal 10 in the folded state, and also making it smaller in size, which is more conducive to storage and carrying.

In some embodiments, when in the folded state, the second sub-arm 122 and the first sub-arm 121 can be fixed by any of the following methods: magnetic connection, snap-fit, adhesive, or interference fit. This ensures a reliable connection between the first sub-arm 121 and the second sub-arm 122 in the folded state without loosening, further ensuring that the handheld gimbal 10 has a compact structure and regular shape in the folded state.

For example, magnetic components (such as magnets) with opposite polarities can be provided on the inner or outer surfaces of the second sub-arm 122 and the first sub-arm 121 to achieve magnetic attraction connection between the second sub-arm 122 and the first sub-arm 121 in the folded state.

For example, the second sub-arm 122 and the first sub-arm 121 can be connected by a snap-fit.

For example, the second sub-arm 122 and the first sub-arm 121 can be detachably attached using a hook and loop fastener.

In some embodiments, when in the folded state, the second sub-arm 122 and the handle 400 can be fixed by any of the following methods: magnetic connection, snap-fit, adhesive, or interference fit. This ensures a reliable connection between the second sub-arm 122 and the handle 400 in the folded state without loosening, further ensuring that the handheld gimbal 10 has a compact structure and regular shape in the folded state.

For example, magnetic components (such as magnets) with opposite polarities can be provided on the inner or outer surfaces of the second sub-arm 122 and the handle 400 to achieve magnetic connection between the second sub-arm 122 and the handle 400 in the folded state.

For example, the second sub-arm 122 and the handle 400 can be connected by a snap-fit.

For example, the second sub-arm 122 and the handle 400 can be detachably attached using a hook and loop fastener.

In some embodiments, when in the folded state, the second shaft arm 220 is fixed to the handle 400 by any of the following methods: magnetic connection, snap-fit, adhesive, or interference fit. This ensures a reliable connection between the second shaft arm 220 and the handle 400 in the folded state, preventing loosening and further ensuring that the handheld gimbal 10 has a compact structure and regular shape in the folded state.

For example, magnetic components (such as magnets) with opposite polarities can be provided on the inner or outer surfaces of the second shaft arm 220 and the handle 400 to achieve magnetic connection between the second shaft arm 220 and the handle 400 in the folded state.

For example, the second shaft arm 220 and the handle 400 can be connected by a snap-fit mechanism.

For example, the second shaft arm 220 and the handle 400 can be detachably attached using a hook and loop fastener.

Specifically, in some embodiments, a fixing structure 800 is provided between the second shaft arm 220 and the outer peripheral surface of the handle 400. In the folded state, the second shaft arm 220 and the handle 400 are fixed by the fixing structure 800. More specifically, as shown in FIG. 2, in some embodiments, the fixing structure 800 includes a snap-fit protrusion 810 and a snap-fit recess 820. The snap-fit protrusion 810 is provided on either the outer peripheral surface of the handle 400 or the second shaft arm 220, and the snap-fit recess 820 is provided on the other. In the folded state, the handle 400 engages with the second shaft arm 220 through the snap-fit recess 820 and the snap-fit protrusion 810.

For example, as shown in FIG. 2, in some embodiments, the second shaft arm 220 is provided with a snap-fit protrusion 810 and the handle 400 is provided with a snap-fit recess 820. In the folded state, the handle 400 engages with the second shaft arm 220 through the snap-fit recess 820 and the snap-fit protrusion 810.

For example, in other embodiments, the second shaft arm 220 is provided with a snap-fit recess 820, and the handle 400 is provided with a snap-fit protrusion 810. In the folded state, the handle 400 is engaged with the second shaft arm 220 through the engagement of the snap-fit protrusion 810 and the snap-fit recess 820.

Please refer to FIG. 3. In some embodiments, the axis of the first motor 110 is set at an angle to the axis of the handle 400 at a first predetermined angle a, where the first predetermined angle a is 10-45 degrees. As shown in FIG. 1, when the user selects to switch the handheld gimbal 10 to the unfolded state, as described above, the second shaft assembly 200, the third shaft assembly 300, and the shooting device 20 clamped therebetween are all located above the axis of the first motor 110 at the top of the handle 400. Generally, when the user grips the handle 400, they will often choose to adjust the shooting device 20 to a position higher than the handle 400, so that the shooting device 20 is roughly at the same height as the user's eyes, making it easier for the user to observe the screen of the shooting device 20 to understand the shooting situation. Therefore, this embodiment is set up in this way to increase the pitch operating angle of the handheld gimbal 10, which is more in line with the user's usual posture of the handheld gimbal 10 and the shooting device 20 clamped therebetween, and is more in line with the user's usage habits, thereby bringing a better user experience.

Referring to FIG. 3, in some embodiments, a length extension direction of the first sub-arm 121 is set at an angle to a cross-section of the first motor 110 at a second predetermined angle b, where the second predetermined angle b is 0-45 degrees. This setting can increase the pitch operating angle of the handheld gimbal 10, providing a better user experience.

Please refer to FIG. 4. In some embodiments, the length extension direction of the first sub-arm 121 is perpendicular to the axis of the first motor 110.

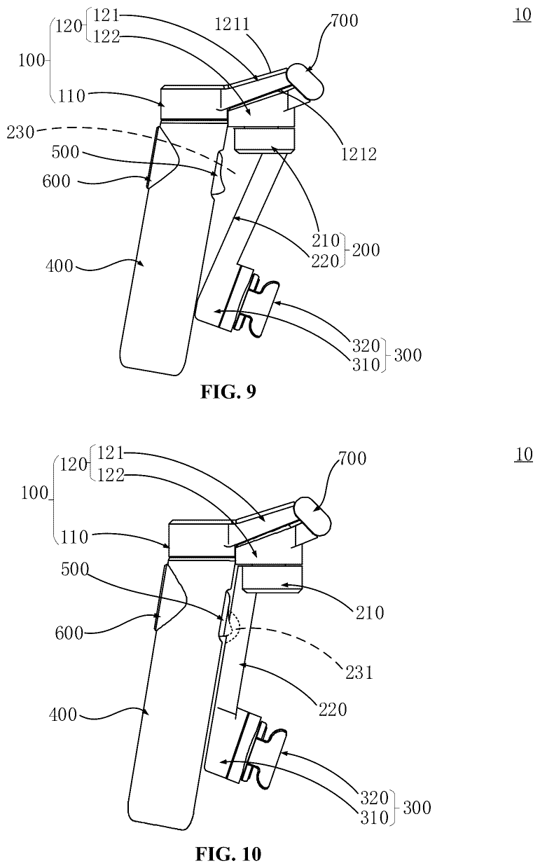

Please refer to FIGS. 9, 10, and 11. In some embodiments, the outer peripheral surface of the handle 400 is provided with a button 500 and/or a control component 600. In the folded state, the second shaft assembly 200 and the outer peripheral surface of the handle 400 form a clearance space 230 for accommodating the button 500 and/or the control component 600. The button 500 and the control component 600 are generally located on the outer peripheral surface of the handle 400. While convenient for operation, they often occupy a certain amount of space. Therefore, in the folded state, to ensure that the second shaft assembly 200 is at least partially close to or even conforms to the outer peripheral surface of the handle 400, a certain clearance space 230 needs to be provided between the second shaft assembly 200 and the outer peripheral surface of the handle 400 to avoid the button 500 and/or the control component 600, thereby ensuring that the structure of the handheld gimbal 10 in the folded state is sufficiently compact.

Furthermore, as shown in FIGS. 9, 10 and 11, in some embodiments, the second shaft arm 220 of the second shaft assembly 200 forms a clearance space 230 with the outer peripheral surface of the handle 400 for accommodating the button 500 and/or the control component 600.

Furthermore, as shown in FIGS. 9, 10, and 11, to make the button 500 easier to operate, it can be made to protrude slightly from the outer peripheral surface of the handle 400. Similarly, the control component 600 can also be made to protrude slightly from the outer peripheral surface of the handle 400. The button 500 and the control component 600 are generally located on the outer peripheral surface of the handle 400. While this facilitates operation, they often occupy a certain amount of space. Therefore, in the folded state, to ensure that the second shaft arm 220 is at least partially close to or even against the outer peripheral surface of the handle 400, a certain clearance space 230 needs to be provided between the second shaft arm 220 and the outer peripheral surface of the handle 400 to avoid the button 500 and/or the control component 600, thereby ensuring that the structure of the handheld gimbal 10 in the folded state is sufficiently compact.

It should be noted that the clearance space 230 can be considered as being formed solely by the handle 400, solely by the second shaft arm 220, or enclosed by the outer periphery of the handle 400 and the second shaft arm 220.

For example, in some embodiments, the outer peripheral surface of a portion of the handle 400 may be recessed to accommodate the button 500 and/or the control component 600, i.e., the outer peripheral surface of a portion of the handle 400 may be recessed to form the clearance space 230, in which case the clearance space 230 may be considered to be formed solely by the handle 400.

For example, as shown in FIG. 9, in some embodiments, when the folded state is in the folded state, the end of the second shaft arm 220 away from the second motor 210 is attached to the outer peripheral surface of the handle 400, and the end of the second shaft arm 220 near the second motor 210 is spaced apart from the outer peripheral surface of the handle 400 to form the clearance space 230. At this time, it can be considered that the clearance space 230 is formed by the outer peripheral surface of the handle 400 and the second shaft arm 220.

For example, as shown in FIG. 10, in some embodiments, the second shaft arm 220 is provided with a clearance groove 231. The clearance groove 231 also has space for clearance of the button 500 and/or the control component 600. It can be considered that the clearance groove 231 also provides clearance space 230. In the folded state, the button 500 and/or the control component 600 are housed in the clearance groove 231. At this time, it can be considered that the clearance space 230 is formed solely by the second shaft arm 220.

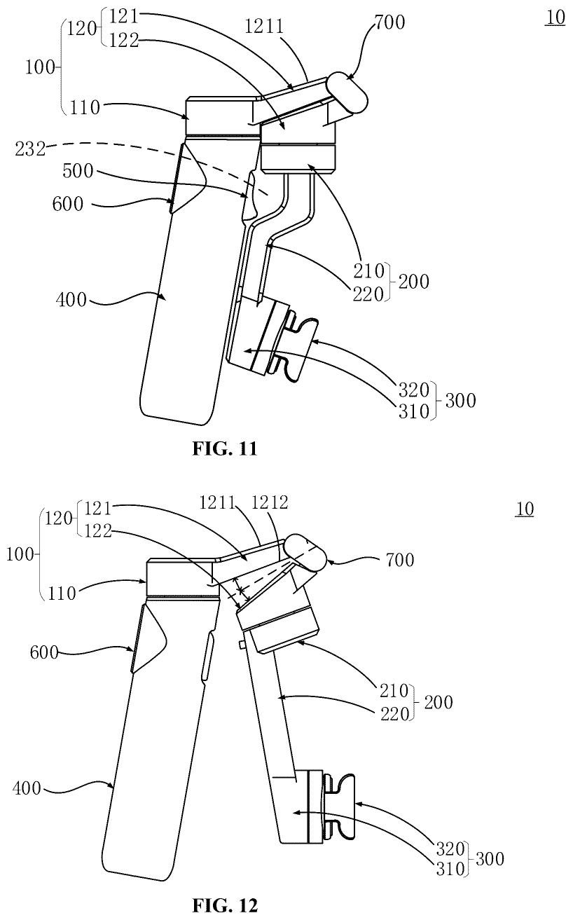

For example, as shown in FIG. 11, in some embodiments, the second shaft arm 220 is at least partially bent to form a clearance opening 232. It can be considered that the clearance opening 232 also provides a clearance space 230. In the folded state, the button 500 and/or the control component 600 are accommodated in the clearance opening 232. At this time, it can be considered that the clearance space 230 is formed solely by the second shaft arm 220, or it can be considered that it is formed by the outer peripheral surface of the handle 400 and the second shaft arm 220.

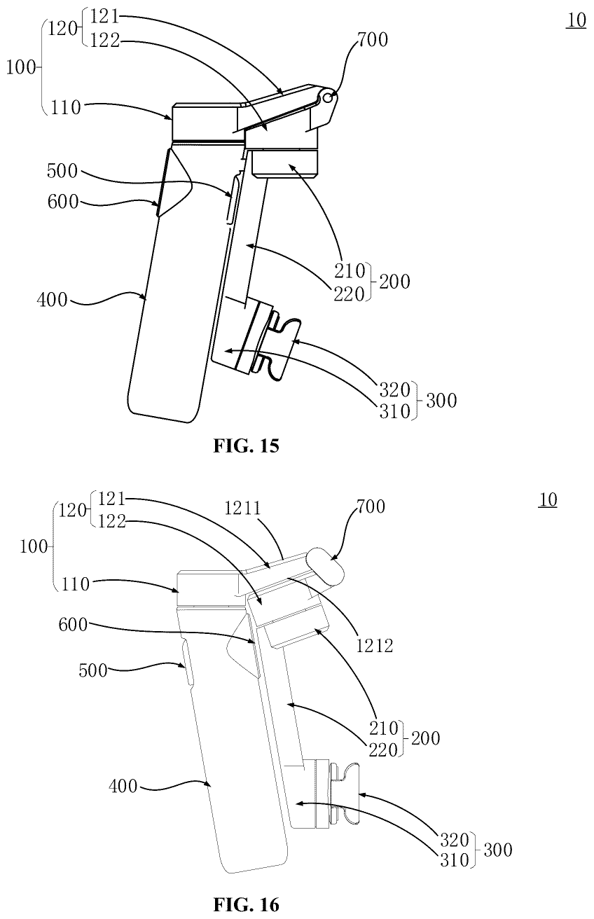

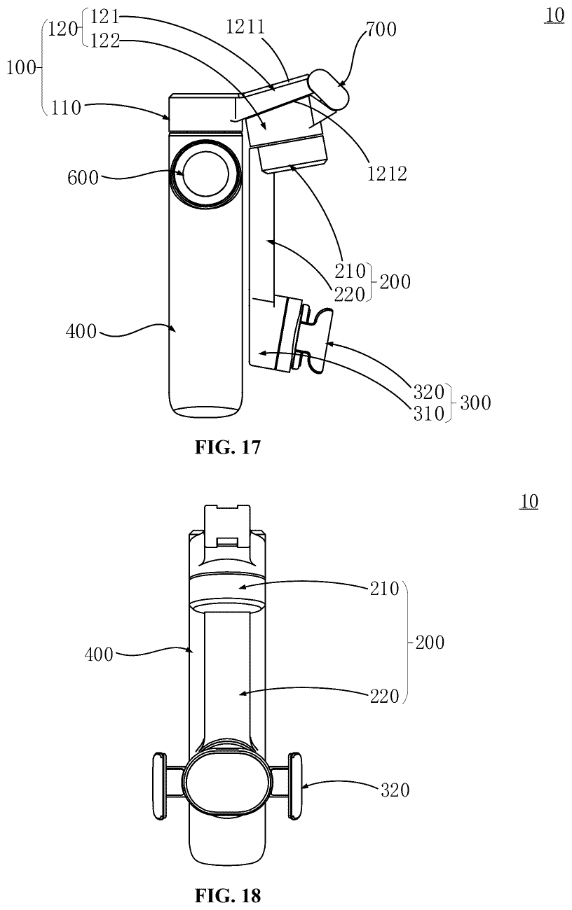

Further, as shown in FIGS. 15, 16, and 17, the button 500 and the control component 600 are respectively located on both sides of the outer peripheral surface of the handle 400, and the second shaft arm 220 and/or the second sub-arm 122 can be attached to any side of the outer peripheral surface of the handle 400. For example, as shown in FIG. 15, in some embodiments, the second shaft arm 220 and/or the second sub-arm 122 are attached to the outer peripheral surface of the handle 400 and located on the side where the button 500 is located. As shown in FIG. 16, in some embodiments, the second shaft arm 220 and/or the second sub-arm 122 are attached to the outer peripheral surface of the handle 400 and located on the side where the control component 600 is located. As shown in FIG. 17, in some embodiments, the second shaft arm 220 and/or the second sub-arm 122 are attached to the outer peripheral surface of the handle 400 but are not directly opposite the button 500 or the control component 600.

As shown in FIGS. 15, 16, and 17, the button 500 and the control component 600 are located on opposite sides of the outer peripheral surface of the handle 400, and the second shaft arm 220 and/or the second sub-arm 122 may be attached to any side of the outer peripheral surface of the handle 400. For example, as shown in FIG. 15, in some embodiments, the second shaft arm 220 and/or the second sub-arm 122 are attached to the outer peripheral surface of the handle 400 and located on the side where the button 500 is located. As shown in FIG. 16, in some embodiments, the second shaft arm 220 and/or the second sub-arm 122 are attached to the outer peripheral surface of the handle 400 and located on the side where the control component 600 is located. As shown in FIG. 17, in some embodiments, the second shaft arm 220 and/or the second sub-arm 122 are attached to the outer peripheral surface of the handle 400 but are not directly opposite the button 500 or the control component 600.

It should be noted that the control component can refer to parts such as a control panel, a dial assembly, or an joystick, which can be used to control the handheld gimbal 10 and/or the shooting device 20. Taking the dial assembly and joystick as examples, the dial assembly is a control component that collects user control commands through different rotation amounts. When using it, the user can easily control the shooting device 20 by adjusting the rotation of the wheel in the dial assembly. For example, the user can adjust the ISO, white balance, focus, scrolling options, and switching settings of the shooting device 20 by rotating the dial assembly clockwise/counterclockwise. The joystick is a control component with a high degree of freedom that collects user control commands by moving and/or rotating the stick in different directions. When using it, the user can easily control the shooting device 20 by moving the joystick. For example, the user can easily select one or more focus points from multiple focus points and change the rotation angle of the shaft assembly by moving the joystick.

Please refer to FIGS. 7 and 8. The shapes of the first sub-arm 121 and the second sub-arm 122 of this application can be varied.

For example, as shown in FIGS. 7, 15, 16 and 17, in some embodiments, the first sub-arm 121 can be a straight arm, and the first sub-arm 121 and the second sub-arm 122 are adapted in shape and size. That is, in the folded state, the first sub-arm 121 and the second sub-arm 122 can be as close to each other as possible or even fit together, so that the two structures are compact.

FIG. 18 can be considered as a side view of FIG. 15 or FIG. 16. As shown in FIG. 18, when the handheld gimbal 10 is in the folded state, the first sub-arm 121 is a straight arm and the second shaft arm 220 is directly opposite the button 500 or control component 600 of the handle. The second shaft arm 220 is just aligned with the handle 400, and the overall shape of the handheld gimbal 10 is neat and beautiful.

For example, in some embodiments, the first sub-arm 121 can be a curved arm, and the first sub-arm 121 and the second sub-arm 122 are adapted in shape and size, that is, in the folded state, the first sub-arm 121 and the second sub-arm 122 can be as close to each other as possible or even fit together, so that the two structures are compact.

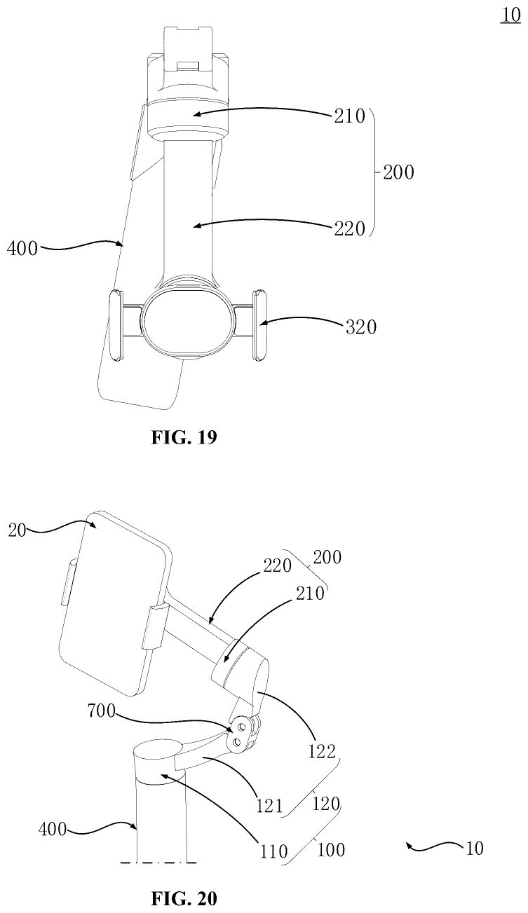

Furthermore, the first sub-arm 121 can be a curved arm, that is, a bent first sub-arm 121, which can be a segmented curved arm connected by multiple straight arms as shown in FIG. 8, or an arc-shaped arm as shown in FIG. 20.

In one embodiment shown in FIG. 19, the second shaft arm 220 is not aligned with the button 500 or the control component 600 after being folded. Since there is an angle between the axis of the handle 400 and the axis of the first motor 110, the second shaft arm 220 cannot be aligned with the handle 400.

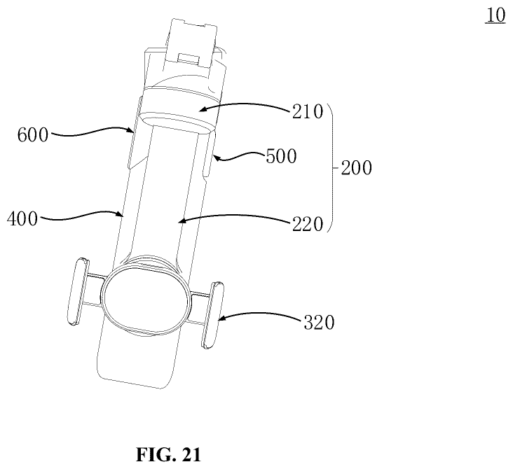

In the embodiments shown in FIGS. 20 and 21, the first sub-arm 121 can be a curved arm. Although there is an angle between the axis of the handle 400 and the axis of the first motor 110, and the second shaft arm 220 is not directly facing the button 500 or the control component 600 after being folded, since the first sub-arm 121 is a curved arm and the second sub-arm 122 is adapted to the first sub-arm 121, it is equivalent to the arc-shaped first sub-arm 121 being appropriately twisted at a certain angle, so that the second shaft arm 220 is still aligned with the handle 400.

In other words, the problems that arise when the first sub-arm 121 in the embodiment of FIG. 19 is a straight arm can be avoided by the arc-shaped first sub-arm 121 in the embodiments of FIG. 20 and FIG. 21.

Please refer to FIGS. 12, 13, 14 and 15. In some embodiments, the handheld gimbal 10 further includes a rotating member 700, through which the first sub-arm 121 is rotatably connected to the second sub-arm 122.

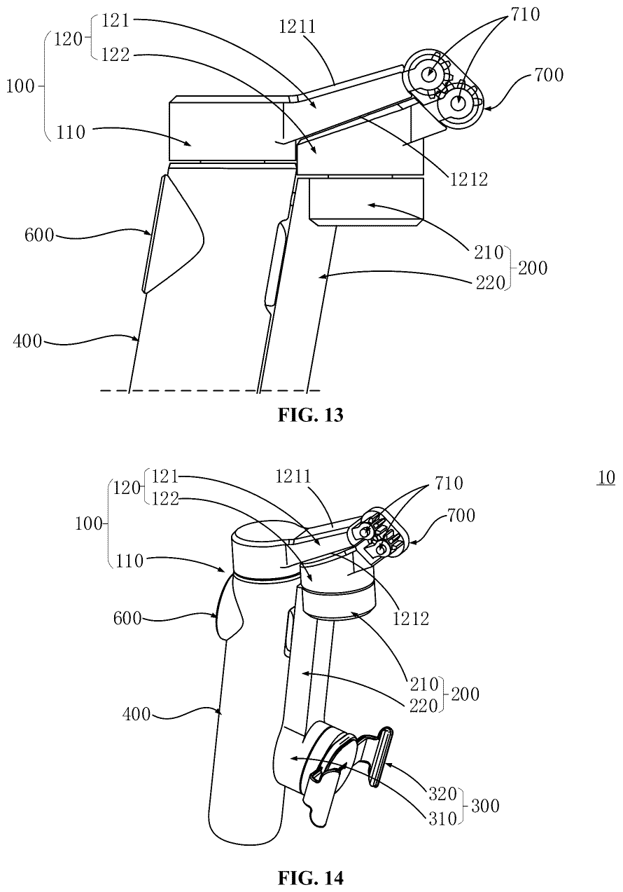

For example, in some embodiments, the rotating member 700 has two rotating shafts 710. The first sub-arm 121 is rotatably sleeved on one of the rotating shafts 710, and the second sub-arm 122 is rotatably sleeved on the other of the rotating shafts 710. The first sub-arm 121 and the second sub-arm 122 rotate synchronously or asynchronously through the rotating member 700. The asynchronous rotation of the first sub-arm 121 and the second sub-arm 122 through the rotating member 700 allows for more freedom in adjustment. As shown in FIG. 12, the synchronous rotation of the first sub-arm 121 and the second sub-arm 122 through the rotating member 700 allows for a halved rotation angle at each rotation center, making folding and unfolding more convenient and faster, rotation more stable and reliable, and the overall structure more regular after storage. Further, as shown in FIGS. 13 and 14, in some embodiments, the first sub-arm 121 rotates synchronously with the second sub-arm 122 through a meshing transmission.

For example, as shown in FIG. 15, in some embodiments, the rotating member 700 is a single rotating shaft 710, and the first sub-arm 121 is rotatably connected to the second sub-arm 122 through the single rotating shaft 710.

The technical features of the above embodiments can be combined in any way. For the sake of brevity, not all possible combinations of the technical features in the above embodiments are described. However, as long as there is no contradiction in the combination of these technical features, they should be considered to be within the scope of this specification.

The embodiments described above are merely illustrative of several implementation methods of this application, and while the descriptions are relatively specific and detailed, they should not be construed as limiting the scope of the patent application. It should be noted that those skilled in the art can make various modifications and improvements without departing from the concept of this application, and these all fall within the protection scope of this application. Therefore, the protection scope of this patent application should be determined by the appended claims.

In the description of this application, it should be understood that if terms such as “center”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential” appear, these terms indicate the orientation or positional relationship based on the orientation or positional relationship shown in the accompanying drawings, and are only for the convenience of describing this application and simplifying the description, and do not indicate or imply that the device or element referred to must have a specific orientation, or be constructed and operated in a specific orientation, and therefore should not be construed as a limitation of this application.

Furthermore, where the terms “first” and “second” appear, these terms are for descriptive purposes only and should not be construed as indicating or implying relative importance or implicitly specifying the number of technical features indicated. Thus, a feature defined with “first” or “second” may explicitly or implicitly include at least one of that feature. In the description of this application, where the term “multiple” appears, “multiple” means at least two, such as two, three, etc., unless otherwise explicitly specified.

In this application, unless otherwise expressly specified and limited, the terms “installation,” “connection,” “joining,” and “fixing,” etc., should be interpreted broadly. For example, they can refer to a fixed connection, a detachable connection, or an integral part; they can refer to a mechanical connection or an electrical connection; they can refer to a direct connection or an indirect connection through an intermediate medium; they can refer to the internal communication of two components or the interaction between two components, unless otherwise expressly limited. Those skilled in the art can understand the specific meaning of the above terms in this application based on the specific circumstances.

In this application, unless otherwise expressly specified and limited, the use of descriptions such as “above” or “below” the second feature indicates that the first and second features are in direct contact or indirect contact via an intermediate medium. Furthermore, “above,” “on top of,” and “over” the second feature can mean that the first feature is directly above or diagonally above the second feature, or simply that the first feature is at a higher horizontal level than the second feature. Similarly, “below,” “at a bottom of,” and “under” the second feature can mean that the first feature is directly below or diagonally below the second feature, or simply that the first feature is at a lower horizontal level than the second feature.

It should be noted that if an element is referred to as being “fixed to” or “set on” another element, it can be directly on the other element or there may be an intervening element. If an element is considered to be “connected to” another element, it can be directly connected to the other element or there may be an intervening element. If so, the terms “vertical,” “horizontal,” “upper,” “lower,” “left,” “right,” and similar expressions used in this application are for illustrative purposes only and do not represent the only possible implementation.

In the description of this specification, references to terms such as “an embodiment,” “another implementation,” etc., indicate that a specific feature, structure, material, or characteristic described in connection with that embodiment or example is included in at least one embodiment or example of this application. In this specification, the illustrative descriptions of the above terms do not necessarily refer to the same embodiment or example. Unless otherwise defined, all technical and scientific terms used herein have the same meaning as commonly understood by one of ordinary skill in the art to which this application belongs. The terminology used herein is for the purpose of describing particular embodiments only and is not intended to be limiting of this application.

What is claimed is:

1. A handheld gimbal, comprising
a handle; and
a first shaft assembly including a first motor and a first shaft arm disposed on the handle, the first shaft arm including a first sub-arm and a second sub-arm rotatably connected to the first sub-arm, one end of the first sub-arm being connected to the first motor,
wherein, in a radial direction of the first motor, the first sub-arm at least partially protrudes from an outer peripheral surface of the first motor,
the first sub-arm has a first surface and a second surface opposite to each other, the first surface being located at a side of the first motor away from the handle,
the first motor is configured to drive the first sub-arm to rotate relative to the handle, and
the handheld gimbal is configured to switch between an unfolded state and a folded state, and in the folded state, the second sub-arm is stored within the second surface.

2. The handheld gimbal according to claim 1, wherein the second sub-arm being stored within the second surface comprises the second sub-arm being stored below the first sub-arm along an axial direction of the handle and at the outer periphery of the handle.

3. The handheld gimbal according to claim 1, wherein one end of the second sub-arm is rotatably connected to an end of the first sub-arm away from the first motor; and/or,
in the folded state, a portion of a surface of the first sub-arm is parallel to a portion of a surface of the second sub-arm.

4. The handheld gimbal according to claim 3, wherein, in the folded state, the first sub-arm is in contact with the second sub-arm; and/or
the second sub-arm is parallel to the second surface of the first sub-arm; and/or
the second sub-arm is attached to the second surface of the first sub-arm; and/or
a stator of the first motor is connected to one of the handle or the first sub-arm, and a rotor of the first motor is connected to the other of the handle or the first sub-arm.

5. The handheld gimbal according to claim 1, wherein the handheld gimbal further comprises a second shaft assembly, the second shaft assembly comprising a second motor and a second shaft arm connected to the second sub-arm, one end of the second shaft arm being connected to the second motor, the second motor being configured to drive the second shaft arm to rotate, and in the folded position, at least one of the second shaft arm or the second sub-arm being in contact with the handle.

6. The handheld gimbal according to claim 5, wherein the handheld gimbal further comprises a third shaft assembly, the third shaft assembly including a clamping structure to clamp a shooting structure and a third motor, the third motor and the second motor are respectively connected to two ends of the second shaft arm, the third motor is connected to the clamping structure and is configured to drive the clamping structure and the shooting structure to rotate, and in the folded state, the third motor is located between the clamping structure and the handle; and/or,
a stator of the second motor is connected to one of the second shaft arm or the second sub-arm, and a rotor of the second motor is connected to the other of the second shaft arm or the second sub-arm.

7. The handheld gimbal according to claim 5, wherein the handle is provided with a button and/or a control component, the second shaft arm is provided with a clearance groove, and in the folded state, the button and/or the control component are accommodated in the clearance groove.

8. The handheld gimbal according to claim 5, wherein the handle is provided with a button and/or a control component, the second shaft arm is at least partially bent to form a clearance opening, and in the folded state, the button and/or the control component are accommodated in the clearance opening.

9. The handheld gimbal according to claim 5, wherein, in the folded state, the second shaft arm is fixed to the handle by a fixing method of magnetic connection, snap-fit, adhesive, or interference fit.

10. The handheld gimbal according to claim 9, wherein the second shaft arm is provided with one of a snap-fit protrusion or a snap-fit recess, and the handle is provided with the other of the snap-fit protrusion or the snap-fit recess, wherein in the folded state, the handle engages with the second shaft arm through the snap-fit recess and the snap-fit protrusion.

11. The handheld gimbal according to claim 1, wherein the handheld gimbal further comprises at least one of following technical features:
the first sub-arm and/or the second sub-arm are straight arms;
the first sub-arm and/or the second sub-arm are curved arms; or
the first sub-arm and/or the second sub-arm are arc-shaped arms.

12. The handheld gimbal according to claim 1, wherein an axial direction of the first motor and an axial direction of the handle are set at a first predetermined angle, and the first predetermined angle is within a range of 10 degrees to 45 degrees.

13. The handheld gimbal according to claim 1, wherein a length extension direction of the first sub-arm and a cross-section of the first motor are set at a second predetermined angle, and the second predetermined angle is within a range of 0 degree to 45 degrees.

14. The handheld gimbal according to claim 1, wherein a length extension direction of the first sub-arm is perpendicular to an axis of the first motor.

15. The handheld gimbal according to claim 1, wherein, in the folded state, the second sub-arm is fixed to the first sub-arm by a fixing method of magnetic connection, snap-fit, adhesive, or interference fit; and/or,
in the folded state, the second sub-arm is fixed to the handle by a fixing method of magnetic connection, snap-fit, adhesive, or interference fit.

16. The handheld gimbal according to claim 1, wherein the handheld gimbal further comprises a rotating structure, and the first sub-arm is rotatably connected to the second sub-arm through the rotating structure.

17. The handheld gimbal according to claim 16, wherein the rotating structure has two rotating shafts, the first sub-arm is rotatably sleeved on one of the two rotating shafts, and the second sub-arm is rotatably sleeved on the other of the two rotating shafts.

18. The handheld gimbal according to claim 17, wherein the first sub-arm and the second sub-arm rotate synchronously through a meshing transmission.

19. The handheld gimbal according to claim 16, wherein the rotating structure is a single rotating shaft, and the first sub-arm is rotatably connected to the second sub-arm through the single rotating shaft.

20. The handheld gimbal according to claim 1, wherein, during a process of switching from the unfolded state to the folded state, the second sub-arm first rotates away from the handle and then rotates towards an outer periphery of the handle until the second sub-arm is at least partially parallel to the first sub-arm.
